(19) United States
(12) Patent Application Publication
(10) Pub. No.: US 2005/0167219 A1
(43) Pub. Date: Aug. 4, 2005

(54) Vehicle dynamic body control actuator having a directional lip seal

(76) Inventors: Andrew F. Hall, Dayton, OH (US); Mike A. Hollis, South Vienna, OH (US); Steven K. Raypole, Tipp City, OH (US); Scott A. Stacey, Dayton, OH (US)

Correspondence Address: Delphi Technologies, Inc.;Legal Staff - Intellectual Properties, M/C 480-410-202, P.O. Box 5052, Troy, MI, 48007-5052, US

(21) Appl. No.: 10/768,456

(22) Filed: Jan. 30, 2004

(51) Int. Cl. F16F 9/43

(52) U.S. Cl. 188/322.21

(57) ABSTRACT

A vehicle dynamic-body-control actuator includes a fluid-powered-cylinder reservoir tube, a piston, a rod, and a directional lip seal. The reservoir tube has a longitudinal axis and has a first tube end attachable to one of a first vehicle component and a second vehicle component. The piston is positioned within the reservoir tube. The rod has first and second rod end portions, wherein the first rod end portion is attached to the piston and wherein the second rod end portion is attachable to the other of the first and second vehicle components. The directional lip seal surrounds at least one of the rod and the piston, extends to the reservoir tube, and is movable with the rod and the piston.

### TECHNICAL FIELD

The present invention relates generally to vehicles, and more particularly to a fluid-powered cylinder used to raise and lower the vehicle frame with respect to a vehicle suspension system component.

### BACKGROUND OF THE INVENTION

Conventional vehicle piston dampers are known which have one end attached to the vehicle frame and have the other end attached to a vehicle suspension system component. Such piston dampers have a reservoir tube containing a fluid and have a piston which slideably engages the reservoir tube. The fluid passes through an orifice of the piston or past the outer circumference of the piston providing damping of relative motion between the piston and the reservoir tube cause by varying wheel loads during vehicle travel.

Vehicle stability enhancement systems are known which employ MR (magnetorheological) piston dampers wherein exposing the MR fluid in the orifice of the piston to a varying magnetic field, generated by providing a varying electric current to an electric coil of the MR piston, varies the damping effect of the MR fluid in the orifice providing variably-controlled damping of relative motion between the MR piston and the reservoir tube. The electric current is varied to accommodate varying operating conditions, as is known to those skilled in the art, to enhance vehicle stability such as during vehicle turns.

Automobile repair shops employ hydraulic lifts (fluid powered cylinders) to raise and lower automobiles for access to the vehicle underside during vehicle maintenance and repair. Likewise, some elevators employ hydraulic lifts to raise and lower the elevator. It is known to employ directional lip seals in vehicle master brake cylinders.

What is needed is a vehicle dynamic body control actuator useful, in one application employing a front right (or left) actuator and a corresponding rear right (or left) actuator, to controllably raise and lower a side of the vehicle to change the vehicle roll angle to increase vehicle stability during a vehicle turn.

### SUMMARY OF THE INVENTION

In a first expression of a first embodiment of the invention, a vehicle dynamic-body-control actuator includes a fluid-powered-cylinder reservoir tube, a piston, a rod, a washer, a directional lip seal, and a collar. The reservoir tube has a longitudinal axis and has a first tube end attachable to one of a first vehicle component and a second vehicle component. The piston is positioned within the reservoir tube and has at least one internal passageway defining at least one fluid bypass. The rod has a first rod end portion attached to the piston and including a tenon and has a second rod end portion attachable to the other of the first and second vehicle components. The washer surrounds the tenon and is longitudinally supported by the rod. The directional lip seal is attached to the washer and extends to the reservoir tube. The collar surrounds the tenon and is longitudinally positioned between the piston and the washer.

In a first expression of a second embodiment of the invention, a vehicle dynamic-body-control actuator includes a fluid-powered-cylinder reservoir tube, a piston, a rod, a directional lip seal, and a guide band. The reservoir tube has a longitudinal axis and has a first tube end attachable to one of a first vehicle component and a second vehicle component. The piston is positioned within the reservoir tube and is devoid of any fluid bypass. The rod has first and second rod end portions, wherein the first rod end portion is attached to the piston and wherein the second rod end portion is attachable to the other of the first and second vehicle components. The directional lip seal surrounds and is attached to the piston and extends to the reservoir tube. The guide band surrounds and is carried by the piston, extends to the reservoir tube, and has at least one fluid bypass.

In a first expression of a third embodiment of the invention, a vehicle dynamic-body-control actuator includes a fluid-powered-cylinder reservoir tube, a piston, a rod, a full-rod-extension bump stop, and a directional lip seal. The reservoir tube has a longitudinal axis and has a first tube end attachable to one of a first vehicle component and a second vehicle component. The piston is positioned within the reservoir tube and is devoid of any fluid bypass. The rod has a first rod end portion attached to and longitudinally abutting the piston and has a second rod end portion attachable to the other of the first and second vehicle components. The full-rod-extension bump stop surrounds the rod and longitudinally contacts the piston. The directional lip seal is attached to the full-rod-extension bump stop and extends to the reservoir tube.

In a broader expression of each of the first, second, and third embodiments of the invention, a vehicle dynamic-body-control actuator includes a fluid-powered-cylinder reservoir tube, a piston, a rod, and a directional lip seal. The reservoir tube has a longitudinal axis and has a first tube end attachable to one of a first vehicle component and a second vehicle component. The piston is positioned within the reservoir tube. The rod has first and second rod end portions, wherein the first rod end portion is attached to the piston and wherein the second rod end portion is attachable to the other of the first and second vehicle components. The directional lip seal surrounds at least one of the rod and the piston, extends to the reservoir tube, and is movable with the rod and the piston.

Several benefits and advantages are derived from one or more of the first, second, and third embodiments of the invention. In one application, the directional lip seal has a predetermined blow off pressure allowing fluid passage past the lip seal substantially only when the differential fluid pressure across the seal in one longitudinal direction (but not the reverse longitudinal direction) equals or exceeds the predetermined blow off pressure allowing a rod undergoing fluid-powered retraction a softer response when encountering a severe wheel load, as can be appreciated by those skilled in the art.

### SUMMARY OF THE DRAWINGS

FIG. 1 is a schematic longitudinal cross-sectional view of a first embodiment of the vehicle dynamic-body-control actuator of the invention;

FIG. 2 is a schematic longitudinal cross-sectional view of a second embodiment of the vehicle dynamic-body-control actuator of the invention;

FIG. 3 is a side elevational view of the piston of FIG. 2; and

FIG. 4 is a schematic longitudinal cross-sectional view of a third embodiment of the vehicle dynamic-body-control actuator of the invention.

### DESCRIPTION OF THE PREFERRED EMBODIMENTS

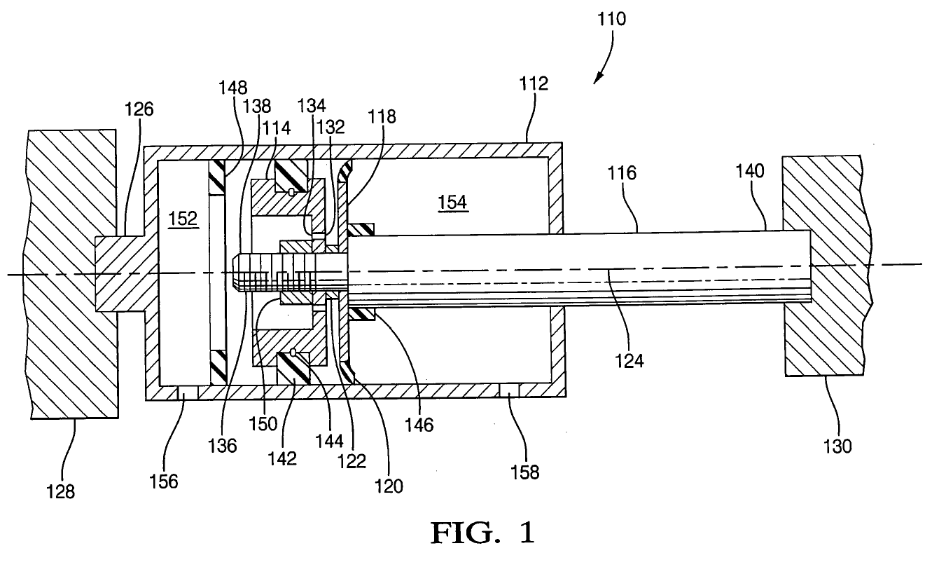

Referring now to the drawings, wherein like numerals represent like elements throughout, FIG. 1 shows a first embodiment of the present invention. A first expression of the first embodiment of FIG. 1 is for a vehicle dynamic-body-control actuator 110 including a fluid-powered-cylinder reservoir tube 112, a piston 114, a rod 116, a washer 118, a directional lip seal 120, and a collar 122. The reservoir tube 112 has a longitudinal axis 124 and has a first tube end 126 attachable to one of a first vehicle component 128 (such as, but not limited to, a vehicle frame) and a second vehicle component 130 (such as, but not limited to, a vehicle suspension system component). It is noted that the first and second vehicle components 128 and 130 are components of the same vehicle. The piston 114 is disposed within the reservoir tube 112 and has at least one internal passageway 132 defining at least one fluid bypass 134. The rod 116 has a first rod end portion 136 attached to the piston 114 and including a tenon 138 and has a second rod end portion 140 attachable to the other of the first and second vehicle components 128 and 130. The washer 118 surrounds the tenon 138 and is longitudinally supported by the rod 116. The directional lip seal 120 is attached to the washer 118 and extends to the reservoir tube 112. The collar 122 surrounds the tenon 138 and is longitudinally disposed between the piston 114 and the washer 118.

In one enablement of the first expression of the first embodiment of FIG. 1, the vehicle dynamic-body-control actuator 110 also includes a guide band 142 surrounding and carried by the piston 114 and extending to the reservoir tube 112. The guide band 142 helps longitudinally guide the piston 114 in the reservoir tube 112 and protects the piston 114 from otherwise striking the side of the reservoir tube 112 during a side load applied perpendicular to the longitudinal axis 124. In one variation, the vehicle dynamic-body-control actuator 110 further includes an “O” ring 144 surrounding and carried by the piston 114 and biasing the guide band 142 toward the reservoir tube 112. In this variation, the “O” ring 144 ensures good fluid sealing between the guide band 142 and the reservoir tube 112.

In one implementation of the first expression of the first embodiment of FIG. 1, the directional lip seal 120 has a predetermined blow off pressure allowing fluid passage past the directional lip seal 120 substantially only when the differential fluid pressure across the directional lip seal 120 in a longitudinal direction from the piston 114 to the directional lip seal 120 equals or exceeds the predetermined blow off pressure. In this implementation, the predetermined blow off pressure of the directional lip seal 120 allows a rod 116 undergoing fluid-powered retraction a softer response when encountering a severe wheel load, as can be appreciated by those skilled in the art.

In one employment of the first expression of the first embodiment of FIG. 1, the vehicle dynamic-body-control actuator 110 also includes a full-rod-retraction bump stop 146 attached to the reservoir tube 112 and further includes a full-rod-extension bump stop 148 longitudinally supported by the washer 118. In this employment, the washer 118 is longitudinally disposed between the collar 122 and the full-rod-extension bump stop 148.

In one arrangement of the first expression of the first embodiment of FIG. 1, a first vehicle dynamic-body-control actuator is employed for the right (passenger-side) front wheel of a vehicle (not shown) and a second vehicle dynamic-body-control actuator is employed for the right rear wheel of the vehicle. Examples of vehicles include, without limitation, automotive vehicles such as cars and trucks. In one variation, fluid pressure in the chambers 152 and 154 in the reservoir tube 112 on each side of the piston 114 are controlled by a vehicle stability enhancement system controller (not shown) to raise or lower the passenger-side of the vehicle during vehicle cornering, as can be appreciated by the artisan. Fluid ports 156 and 158 used by the controller in controlling the fluid pressure in the chambers 152 and 154 are shown in FIG. 1. In one illustration, the tenon 138 is threaded, and a nut 150 is threadably attached to the tenon 138 to attach the first rod end portion 136 to the piston 114 as shown in FIG. 1. In one construction, the directional lip seal 120 and the rod bump stops 146 and 148 each comprise an elastomer, and the guide band 142 comprises polytetrafluoroethylene.

A broader expression of the first embodiment of FIG. 1 is for a vehicle dynamic-body-control actuator 110 including a fluid-powered-cylinder reservoir tube 112, a piston 114, a rod 116, and a directional lip seal 120. The reservoir tube 112 has a longitudinal axis 124 and has a first tube end 126 attachable to one of a first vehicle component 128 and a second vehicle component 130. The piston 114 is disposed within the reservoir tube 112. The rod 116 has first and second rod end portions 136 and 138, wherein the first rod end portion 136 is attached to the piston 114 and wherein the second rod end portion 140 is attachable to the other of the first and second vehicle components 128 and 130. The directional lip seal 120 surrounds at least one of the rod 116 and the piston 114, extends to the reservoir tube 112, and is movable with the rod 116 and the piston 114.

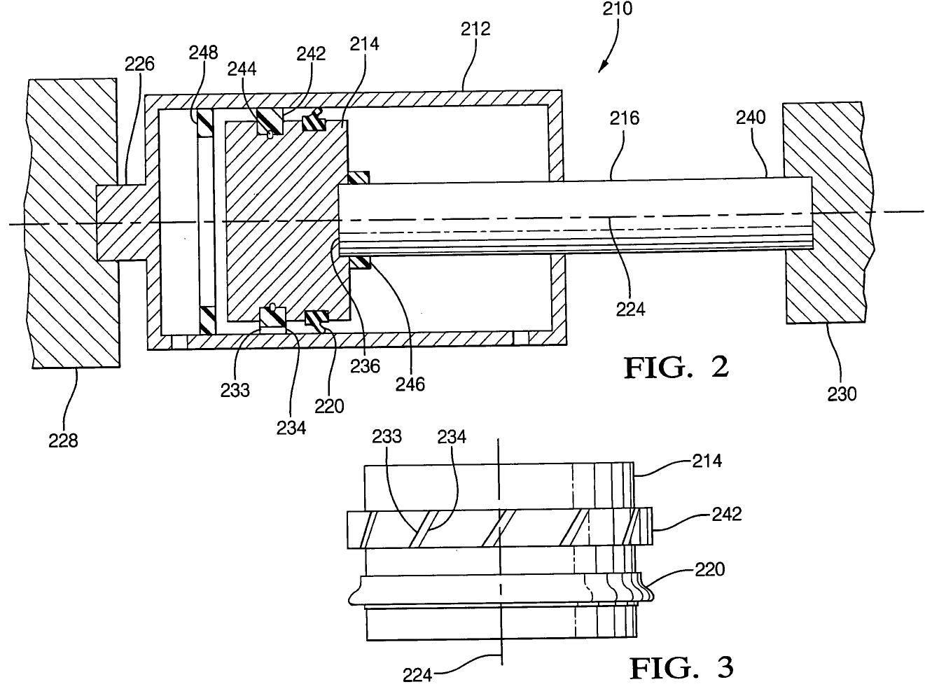

FIG. 2 shows a second embodiment of the present invention. A first expression of the second embodiment of FIG. 2 is for a vehicle dynamic-body-control actuator 210 including a fluid-powered-cylinder reservoir tube 212, a piston 214, a rod 216, a directional lip seal 220, and a guide band 242. The reservoir tube 212 has a longitudinal axis 224 and has a first tube end 226 attachable to one of a first vehicle component 228 and a second vehicle component 230. The piston 214 is disposed within the reservoir tube 212 and is devoid of any fluid bypass. The rod has first and second rod end portions 236 and 240, wherein the first rod end portion 236 is attached to the piston 214 and wherein the second rod end portion 240 is attachable to the other of the first and second vehicle components 228 and 230. The directional lip seal 220 surrounds and is attached to the piston 214 and extends to the reservoir tube 212. The guide band 242 surrounds and is carried by the piston 214, extends to the reservoir tube 212, and has at least one fluid bypass 234.

In one deployment of the first expression of the second embodiment of FIG. 2, the at-least-one fluid bypass 234 includes at least one surface groove 233 (shown in FIGS. 2 and 3). In one variation, the at-least-one surface groove 233 is substantially straight and tilted with respect to the longitudinal axis 224. In one modification, the guide band 242 includes a plurality of substantially evenly-circumferentially-spaced-apart surface grooves 233. Such substantially straight and tilted plurality of surface grooves 233 promotes full circumferential contact of the guide band 242 with the reservoir tube 212 during side loading and also promotes ease of longitudinal movement of the guide band 242 in the reservoir tube 212, as can be appreciated by the artisan.

In one configuration of the first expression of the second embodiment of FIG. 2, the directional lip seal 220 is longitudinally disposed between the guide band 242 and the second rod end portion 240. In one enablement, the vehicle dynamic-body-control actuator 210 also includes an “O” ring 244 surrounding and carried by the piston 214 and biasing the guide band 242 toward the reservoir tube 212. In one implementation, the directional lip seal 220 has a predetermined blow off pressure allowing fluid passage past the directional lip seal 220 substantially only when the differential fluid pressure across the directional lip seal 220 in a longitudinal direction from the first rod end portion 236 to the second rod end portion 240 equals or exceeds the predetermined blow off pressure. In one employment, the vehicle dynamic-body-control actuator 210 also includes a full-rod-retraction bump stop 246 attached to the reservoir tube 212 and includes a full-rod-extension bump stop 248 longitudinally supported by the piston 214.

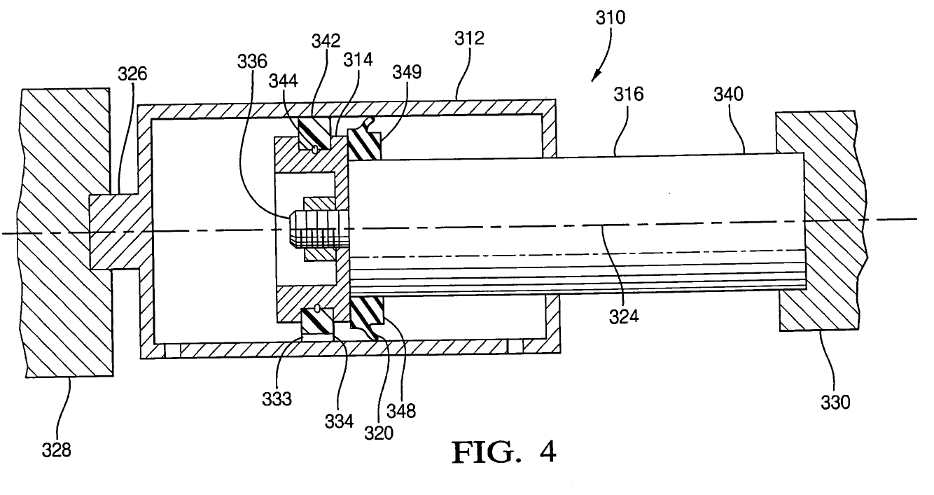

FIG. 4 shows a third embodiment of the present invention. A first expression of the third embodiment of FIG. 4 is for a vehicle dynamic-body-control actuator 310 including a fluid-powered-cylinder reservoir tube 312, a piston 314, a rod 316, a full-rod-extension bump stop 348, and a directional lip seal 320. The reservoir tube 312 has a longitudinal axis 324 and has a first tube end 326 attachable to one of a first vehicle component 328 and a second vehicle component 330. The piston 314 is disposed within the reservoir tube 312 and is devoid of any fluid bypass. The rod 316 has a first rod end portion 336 attached to and longitudinally abutting the piston 314 and has a second rod end portion 340 attachable to the other of the first and second vehicle components 328 and 330. The full-rod-extension bump stop 348 surrounds the rod 316 and longitudinally contacts the piston 314. The directional lip seal 320 is attached to the full-rod-extension bump stop 348 and extends to the reservoir tube 312.

In one construction of the first expression of the third embodiment of FIG. 4, the full-rod-extension bump stop 348 and the directional lip seal 320 define a monolithic member 349. In one implementation, the directional lip seal 320 has a predetermined blow off pressure allowing fluid passage past the directional lip seal 320 substantially only when the differential fluid pressure across the directional lip seal 320 in a longitudinal direction from the piston 314 to the directional lip seal 320 equals or exceeds the predetermined blow off pressure.

In one enablement of the first expression of the third embodiment of FIG. 4, the vehicle dynamic-body-control actuator 310 also includes a guide band 342 surrounding and carried by the piston 314, extending to the reservoir tube 312, and having at least one fluid bypass 334. In one deployment, the at-least-one fluid bypass 334 includes at least one surface groove 333. In one variation, the at-least-one surface groove 333 is substantially straight and tilted with respect to the longitudinal axis 324. In one modification, the guide band 342 includes a plurality of substantially evenly-circumferentially-spaced-apart surface grooves 333. In one option, the vehicle dynamic-body-control actuator 310 also includes an “O” ring 344 surrounding and carried by the piston 314 and biasing the guide band 342 toward the reservoir tube 312. In another option, the guide band 342 is devoid of any underlying “O” ring biasing the guide band 342 toward the reservoir tube 312.

In one example of the vehicle dynamic-body-control actuator 110, 210 and 310, the fluid-powered-cylinder reservoir tube 112, 212 and 312 contains an automatic transmission fluid. Other examples of fluids are left to the artisan.

Several benefits and advantages are derived from one or more of the first, second, and third embodiments of the invention. In one application, the directional lip seal has a predetermined blow off pressure allowing fluid passage past the lip seal substantially only when the differential fluid pressure across the seal in one longitudinal direction (but not the reverse longitudinal direction) equals or exceeds the predetermined blow off pressure allowing a rod undergoing fluid-powered retraction a softer response when encountering a severe wheel load, as can be appreciated by those skilled in the art.

The foregoing description of several embodiments and expressions of the invention has been presented for purposes of illustration. It is not intended to be exhaustive or to limit the invention to the precise form disclosed, and obviously many modifications and variations are possible in light of the above teaching. It is intended that the scope of the invention be defined by the claims appended hereto.

1. A vehicle dynamic-body-control actuator comprising:
a) a fluid-powered-cylinder reservoir tube having a longitudinal axis and having a first tube end attachable to one of a first vehicle component and a second vehicle component;
b) a piston disposed within the reservoir tube;
c) a rod having first and second rod end portions, wherein the first rod end portion is attached to the piston and wherein the second rod end portion is attachable to the other of the first and second vehicle components; and
d) a directional lip seal surrounding at least one of the rod and the piston, extending to the reservoir tube, and movable with the rod and the piston.

2. A vehicle dynamic-body-control actuator comprising:
a) a fluid-powered-cylinder reservoir tube having a longitudinal axis and having a first tube end attachable to one of a first vehicle component and a second vehicle component;
b) a piston disposed within the reservoir tube and having at least one internal passageway defining at least one fluid bypass;
c) a rod having a first rod end portion attached to the piston and including a tenon and having a second rod end portion attachable to the other of the first and second vehicle components;
d) a washer surrounding the tenon and longitudinally supported by the rod;
e) a directional lip seal attached to the washer and extending to the reservoir tube; and
f) a collar surrounding the tenon and longitudinally disposed between the piston and the washer.

3. The vehicle dynamic-body-control actuator of claim 2, also including a guide band surrounding and carried by the piston and extending to the reservoir tube.

4. The vehicle dynamic-body-control actuator of claim 3, also including an “O” ring surrounding and carried by the piston and biasing the guide band toward the reservoir tube.

5. The vehicle dynamic-body-control actuator of claim 2, wherein the directional lip seal has a predetermined blow off pressure allowing fluid passage past the directional lip seal substantially only when the differential fluid pressure across the directional lip seal in a longitudinal direction from the piston to the directional lip seal equals or exceeds the predetermined blow off pressure.

6. The vehicle dynamic-body-control actuator of claim 2, also including a full-rod-retraction bump stop attached to the reservoir tube and including a full-rod-extension bump stop longitudinally supported by the washer, wherein the washer is longitudinally disposed between the collar and the full-rod-extension bump stop.

7. A vehicle dynamic-body-control actuator comprising:
a) a fluid-powered-cylinder reservoir tube having a longitudinal axis and having a first tube end attachable to one of a first vehicle component and a second vehicle component;
b) a piston disposed within the reservoir tube and devoid of any fluid bypass;
c) a rod having first and second rod end portions, wherein the first rod end portion is attached to the piston and wherein the second rod end portion is attachable to the other of the first and second vehicle components;
d) a directional lip seal surrounding and attached to the piston and extending to the reservoir tube; and
e) a guide band surrounding and carried by the piston, extending to the reservoir tube, and having at least one fluid bypass.

8. The vehicle dynamic-body-control actuator of claim 7, wherein the at-least-one fluid bypass includes at least one surface groove.

9. The vehicle dynamic-body-control actuator of claim 8, wherein the at-least-one surface groove is substantially straight and tilted with respect to the longitudinal axis.

10. The vehicle dynamic-body-control actuator of claim 7, wherein the directional lip seal is longitudinally disposed between the guide band and the second rod end portion.

11. The vehicle dynamic-body-control actuator of claim 7, also including an “O” ring surrounding and carried by the piston and biasing the guide band toward the reservoir tube.

12. The vehicle dynamic-body-control actuator of claim 7, wherein the directional lip seal has a predetermined blow off pressure allowing fluid passage past the directional lip seal substantially only when the differential fluid pressure across the directional lip seal in a longitudinal direction from the first rod end portion to the second rod end portion equals or exceeds the predetermined blow off pressure.

13. The vehicle dynamic-body-control actuator of claim 7, also including a full-rod-retraction bump stop attached to the reservoir tube and including a full-rod-extension bump stop longitudinally supported by the piston.

14. A vehicle dynamic-body-control actuator comprising:
a) a fluid-powered-cylinder reservoir tube having a longitudinal axis and having a first tube end attachable to one of a first vehicle component and a second vehicle component;
b) a piston disposed within the reservoir tube and devoid of any fluid bypass;
c) a rod having a first rod end portion attached to and longitudinally abutting the piston and having a second rod end portion attachable to the other of the first and second vehicle components;
d) a full-rod-extension bump stop surrounding the rod and longitudinally contacting the piston; and
e) a directional lip seal attached to the full-rod-extension bump stop and extending to the reservoir tube.

15. The vehicle dynamic-body-control actuator of claim 14, wherein the full-rod-extension bump stop and the directional lip seal define a monolithic member, and wherein the directional lip seal has a predetermined blow off pressure allowing fluid passage past the directional lip seal substantially only when the differential fluid pressure across the directional lip seal in a longitudinal direction from the piston to the directional lip seal equals or exceeds the predetermined blow off pressure.

16. The vehicle dynamic-body-control actuator of claim 14, also including a guide band surrounding and carried by the piston, extending to the reservoir tube, and having at least one fluid bypass.

17. The vehicle dynamic-body-control actuator of claim 16, wherein the at-least-one fluid bypass includes at least one surface groove.

18. The vehicle dynamic-body-control actuator of claim 17, wherein the at-least-one surface groove is substantially straight and tilted with respect to the longitudinal axis.

19. The vehicle dynamic-body-control actuator of claim 14, also including an “O” ring surrounding and carried by the piston and biasing the guide band toward the reservoir tube.

20. The vehicle dynamic-body-control actuator of claim 14, wherein the guide band is devoid of any underlying “O” ring biasing the guide band toward the reservoir tube.
